(19) United States
(12) Patent Application Publication
(10) Pub. No.: US 2009/0245510 A1
(43) Pub. Date: Oct. 1, 2009

(54) BLOCK CIPHER WITH SECURITY INTRINSIC ASPECTS

(76) Inventors: Mathieu CIET, Paris (FR); Augustin J. Farrugia, Cupertino, CA (US); Gianpaolo Fasoli, Palo Alto, CA (US); Filip Paun, Cupertino, CA (US)

Correspondence Address: APPLE C/O MORRISON AND FOERSTER ,LLP;LOS ANGELES, 555 WEST FIFTH STREET SUITE 3500, LOS ANGELES, CA, 90013-1024, US

(21) Appl. No.: 12/055,244

(22) Filed: Mar. 25, 2008

(51) Int. Cl. H04L 9/06

(52) U.S. Cl. 380/29

(57) ABSTRACT

A block cipher or other cryptographic process intended to be efficiently implemented in hardware (circuitry) includes an s-box (substitution operation) which does not require a look up table, but may be implemented solely with Boolean logic operations (logic gates). Also provided is an associated key scheduling process.

### FIELD OF THE INVENTION

This disclosure relates to data security, cryptography, and specifically to block ciphers.

### BACKGROUND

Cryptographic algorithms are widely used for encryption of messages, authentication, encryption signatures and identification. The well-known DES (Data Encryption Standard) has been in use for a long time, and was updated by Triple-DES, which has been replaced in many applications by the AES (Advance Encryption Standard).

DES, Triple-DES and AES are all examples of symmetric block ciphers. Block ciphers operate on blocks of plaintext and ciphertext, usually of 64 bits but sometimes longer. Stream ciphers are the other main type of cipher and operate on streams of plain text and cipher text 1 bit or byte (sometimes one word) at a time. With a block cipher, a particular plain text block will always be encrypted to the same cipher text block using the same key. However, to the contrary with a stream cipher, the same plain text bit or byte will be encrypted to a different bit or byte each time it is encrypted. Hence in the ECB (electronic code book) mode for block ciphers, each plain text block is encrypted independently.

The Advanced Encryption Standard is a block cipher approved as an encryption standard by the U.S. Government. Unlike DES, it is a substitution permutation network. AES is fast to execute in both software and hardwares, relatively easy to implement, and requires little memory. AES has a fixed block size of 128 bits and a key size of 128, 192 or 256 bits. Due to the fixed block size of 128 bits, AES operates on a 4×4 array of bytes. It uses key expansion and like most block ciphers a set of encryption and decryption rounds (iterations). Each round involves the same processes. Use of multiple rounds enhances security. Block ciphers of this type use in each round a substitution box or s-box. This operation provides non-linearity in the cipher and significantly enhances security.

Note that these block ciphers are symmetric ciphers. The same algorithm and key are used for encryption and decryption, except usually for minor differences in the key schedule. As is typical in most modern ciphers, all security rests with the key rather than the algorithm. The s-boxes or substitution boxes were introduced in DES and accept an n bit input and provide an m bit output. The values of m and n vary with the cipher. The input bits specify an entry in the s-box in a particular manner well known in the field.

Block ciphers of this type typically employ what is called a key schedule. This is used because the ciphering and deciphering each occur in rounds (iterations). The general setup of each round is identical, except for some hard coded parameters and part of the cipher key called a sub key which may change round to round. The key schedule is the algorithm or process that given the main (initial) key calculates the sub key for each round. Some ciphers have very simple key schedules. However, DES uses a more complex key schedule where the 56 bit main key is divided into two 28-bit halves, and each half is thereafter treated separately. In successive rounds both halves are rotated bitwise left by 1 or 2 bits as specified for each round, and then various sub key bits are selected by a permutation, also left and right. To avoid simple relationships between the main key and the sub keys (in order to make the ciphers more resistant to related key attacks and slide attacks), many block ciphers use more elaborate key schedules. Some ciphers such as AES use parts of the cipher algorithm itself for this key expansion.

Another issue in cryptography is penetration of ciphers by means of an attack known as transient or permanent fault analysis according to the consequences of the fault injection. Transient fault analysis on a cryptographic algorithm uses differential fault analysis or collision fault analysis. This involves what is called fault injection as a probing tool on the executing hardware (circuitry) in order to penetrate a cipher. Injections are done in various ways. In the field of smart cards, this is achieved by “glitches” on the input power or by directing a laser beam onto the circuitry. For example, by comparing the outputs of two executions, one normal and one faulty, with the same input one infers whether the normal output of a faulted execution is zero or not. Therefore, an identity of cipher text in the two executions implies that the fault was ineffective and reveals a local intermediate value. If the same message faults on two related instructions are both ineffective, then the normal outputs are both equal to zero and it is possible to infer some information about the key. This is a way of extracting keys which is the chief element of security in these types of ciphers. Hence resistance against such a fault analysis attack is desirable.

Further, as well known in the field, encryption and decryption can be performed by software operating on a general purpose computer or microprocessor and/or by dedicated hardware. Hardware here refers to logic circuitry which may include memory (storage) elements. For instance, there are commercially available chips (integrated circuits) for performing DES, AES, etc. with a hardware co-processor. These chips are typically based on gate arrays and provide very high rates of data encryption and decryption, much higher than achievable by software executing on a computer. Furthermore, provision of ciphers and decipherment in chips or logic is generally considered more secure than in software since various hardware based tamper resistant techniques can be used to make the chips resistant to penetration including, for instance, fault analysis. Also, in many situations use of the cipher is needed where no general purpose computer or microprocessor is available such as in certain consumer electronic devices or for RFID tags (radio frequency identification tags). These are purely hardware devices with no provision for programming a microprocessor or general purpose computer.

AES has been widely studied and analyzed. This cipher is well suited for both software and hardware implementation. However, for some “light hardware” implementation, such as RFID (radio frequency identification) where cost is an issue, the number of logic gates required to implement AES in circuitry (not software) is too great for economical implementation.

### SUMMARY

A goal of the block cipher presented here is to provide a very “light hardware” block cipher. This is achieved by using specific well-suited internal functions. For attacks such as fault analysis (described above), the attacker tries to concentrate the fault modification on the last round's operation and then recover the original key, since the key-scheduling operation is invertible. A feature of the present cipher is use of one-wayness in the key schedule. This way, any attacks on the last round succumb on trying to find the original key from the last round's keys. Hence an advantage of this cipher is the difficulty of trying to use the last round key to recover the original (non-expanded) key used for the encryption.

The present block cipher uses some features of known block ciphers such as DES or AES, but is not otherwise the same and uses different operations. For instance, the s-boxes here are not the same as those previously known and are structured to be relatively easy to design in hardware (logic gates). Hence they do not require a lookup table as is typical of the s-boxes in AES and DES. The present cipher is configured to make encryption relatively easy and fast in hardware. The decryption is not as easily accomplished in hardware but is achievable. Hence the emphasis here is on ease of encryption rather than decryption. In some embodiments, the s-box can be simply expressed as a set of Boolean operations for encryption and its inverse for decryption. Several embodiments of the present block cipher are disclosed here. In one embodiment the function used in key scheduling is an invertible operation. In another embodiment a non-invertible operation is used for key scheduling. This non-invertible operation includes use of pseudo random number generation functions.

In addition to the computer enabled block cipher/decipher processes disclosed here, also contemplated is a hardware (logic circuitry) apparatus dedicated to performing these processes, a computer readable storage medium such as a computer memory, disc drive, or CD storing computer code (a program) for carrying out the processes on a general purpose computer or computing device, and a computer or computing device programmed with this computer code. A typical language for software coding of the cipher process is the well known C language.

### BRIEF DESCRIPTION OF THE FIGURES

FIG. 1 shows diagrammatically one round of the present cipher used for encipherment as both a process and as a logic apparatus.

FIG. 2 shows diagrammatically one round of a key scheduling operation for the cipher of FIG. 1.

FIG. 3 shows diagrammatically for a second embodiment one round of an encipherment.

### DETAILED DESCRIPTION

The following introduces the various operations and their associated notations used hereinafter.

1) An s-box s here is, for example, a table lookup or equivalent changing 4 input bits into 4 output bits and being a 16 element array with e.g. one row and 16 columns. This operation is expressed as s={0×4, 0×c, 0×0, 0×8, 0×6, 0×e, 0×1, 0×b, 0×9, 0×d, 0×2, 0×5, 0×9, 0×f, 0×3, 0×7}. This is in conventional hexadecimal notation for the numbers from 0 to 15 where the letters a=10, b=11, . . . , f=15. The s-box is used as a lookup table. For example, if the 4-bit input is 5, this is in hexadecimal 0×5. Then the lookup is at position 6 in the s-box array and the output is the 4-bit output of 0×e. Hence 0 becomes 4; 1 becomes c; 2 becomes 0, etc. For a hardware implementation, it is possible to use conventional Boolean logic operators (AND, OR, XOR, etc.) and storage elements to implement this s-box in circuitry. It is more efficient than a lookup table to achieve this particular s-box (substitution) function s via logic gates in circuitry. If one denotes a, b, c, d as the four input bits to be treated by the s-box and f(a), f(b), f(c), f(d) are the s-box results (output). The four functions f(a), f(b), f(c), f(d) are expressed as f₁ (a,b,c,d), f₂ (a,b,c,d), f₃ (a,b,c,d) and f₄ (a,b,c,d) where:

1) f₁ (a,b,c,d)=a*C+A*d

2) f₂ (a,b,c,d)=a*d+A*C

3) f₃ (a,b,c,d)=a*c*D+b*C+b*d

4) f₄ (a,b,c,d)=a*B*C+a*d+b*c

Here A is the bit complement of a, B is the bit complement of b, etc. and * (multiplication) denotes the Boolean bitwise “AND” operator and+(addition) denotes the Boolean bitwise “OR” operator.

Denote S as the application of the s-box function s to a block of any size.

2) Function RotateXOR is defined as follows, intended to operate on input 32-bit values T:

RotateXOR(T,v)=rotateRight(T,v)̂T

where v is a fixed arbitrary integer value of 1 to 31, and “̂” indicates the Boolean operation of a bitwise XOR. Rotate right is a conventional operation.

3) Function r corresponds to a conventional 8-bit rotateRight. “rotate right” here has its conventional meaning of a circular bit shift. Function r applied to a 64-bit word (W=w0II . . . II w7) is expressed as follows:

r(W)=r(w0,0)IIr(w1,1)II . . . IIr(w7,7),

where “II” denotes concatenation and wi refers to a byte. For instance, r(0×82, 1)=0×05

For an example, for byte w, an 8 bit value, where w=abcdefgh, assume a through h are each just 1 bit. Then:

r(w, 1)=habcdefg

r(w, 2)=ghabcdef

r(w, 3)=fghabcde

r(w, 7)=bcdefgha

r(w, 8)=r(w, 0)=abcdefgh

A concrete example would be r(0×82, 1)=0×05 since 0×82=0100 0001 and if one rotates this 1 bit to the right then the result is 1010 0000=0×05.

So each time one rotates the bits to the right, the right hand most bit gets appended all the way to the left, and not lost.

For a 64-bit word w, then one breaks this word up in 8 bytes as follows:

w=w0 II w1 II w2 II w3 II w4 II w5 II w6 II w7

then r applied on w would be:

r(w)=r(w0,0)II r(w1,1)II . . . II r(w7,7)

that is each byte is individually rotated (as explained above) up to its position in the 64-bit word w. Once the rotations have been performed, take each bye and concatenate them to get r(w).

4) Function R here is defined to carry out a word (a word being a number of bytes) permutation. If one denotes the 64-bit input to R as being 8 bytes numbered from 0 to 7, they are changed (permuted) in order as follows by the R function:

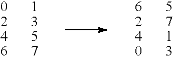

5) A key KRi is employed in each round i using an XOR operation with data being enciphered as explained below.

6) BS denotes an operation here that creates a bisection on bytes. Bijection is well known; a bijective function is a function relating two sets, whereby for every element x in one set, there is exactly one element y in the second set whereby f(x)=y (a one-to-one correspondence). Conventionally this operation for block ciphers is carried out by a large table lookup representing this bijection. Instead of doing this so as to allow an implementation without a look up table and to reduce the code size (for a software implementation), here one uses a bijective affine transformation modulo 2⁸ (equal to modulo 256). The following bijection f(x)=y is used in one embodiment where X is the input byte and 3 and 155 are parameters:

Y=3*X+155 modulo 2⁸

Each input byte X is thereby changed to another output byte value Y. The reverse operation is obtained by:

X=(Y−155)*171 modulo 2⁸=171*Y+119 modulo 2⁸

For instance, value 1 is thereby changed into 158 by the direct (forward) operation. One can check that 1 is recovered by the second (reverse) equation given above.

The main advantage of this solution is that no lookup table has to be stored in memory since this operation can be performed by logic gates working on small numbers. Moreover, since the encryption may be done in hardware, the multiplication by 3 can be simply embodied by four byte additions only, or by a multiplication by 3 if a shift function is available.

BS denotes the above BS operation when applied to a 64-bit word as BS(byte0)II . . . IIBS(byte7).

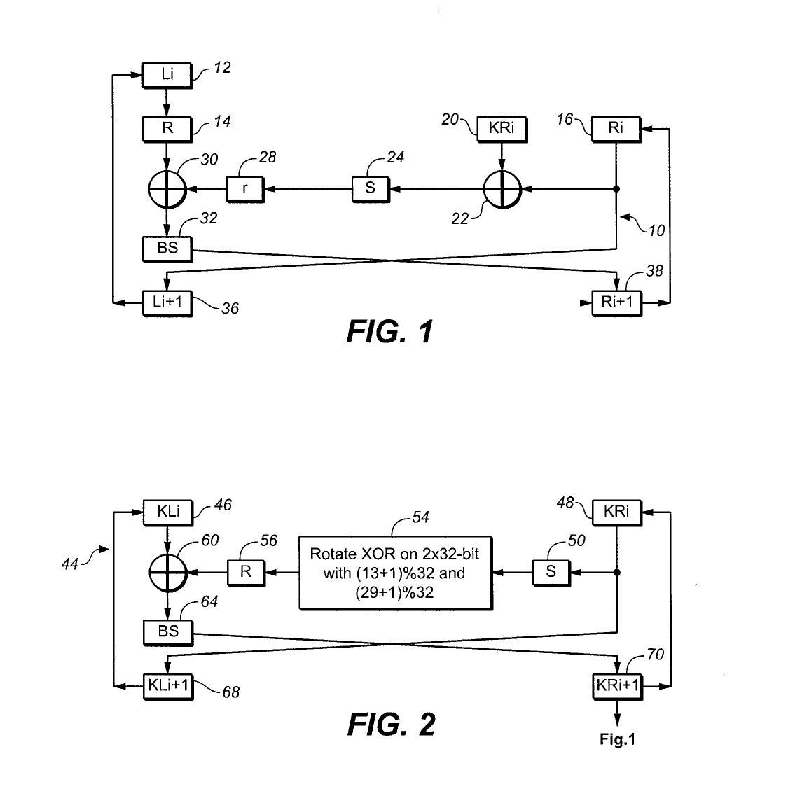

FIG. 1 depicts in diagrammatic (block diagram) form one round of the present encryption process and logic based apparatus 10 using the operations described above. The number of needed rounds is, e.g., 8 to 10 typically, but it may be more for greater security or less for greater efficiency. It is to be appreciated that FIG. 1 shows the processing for a single round of a typical multi-round block encipherment. This encipherment process 10 includes first the provision of the value Li and Ri, which respectively refer to the left (L) and right (R) hand portions of the “message” to be enciphered expressed in binary form for round i. Of course the “message” may not be an actual message, but may be an authentication, signature etc. This message is conventionally split into two equal portions (partitioned) designated L0 II R0 where “II” designates a concatenation. Note that the message has earlier been partitioned into equal length blocks, as standard for block ciphers, prior to the encipherment.

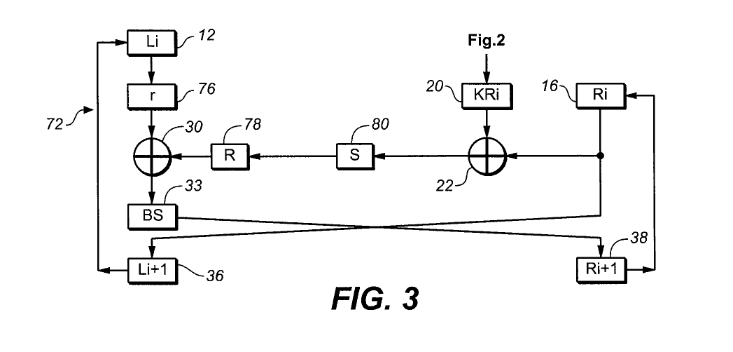

The left hand portion Li stored at 12 is then subject to the R function 14, as described above, which permutes the word defined by Li. In the upper right hand portion of FIG. 1, the Ri portion of the message stored at 16 is logically XORed at logic element 22 with the key KRi for the right hand portion designated at 20 (Ri XOR KRi). The key KRi stored at 20 is generated by the process shown in FIG. 2 and explained below. Each byte of the right hand portion of the message Ri and the key KRi, XORed by element 22, is then subject to the s-box substitution S at 24. (The remaining operations in FIG. 1 are also done on each byte.) The output of s-box 24 is then subject to the 8 bit rotate right function r at 28 as described above. The output of the 8 bit right rotate function 28 is then XORed by element 30 with the output of the rotate R element 14. The resulting output from XOR element 30 is then subject to the BS operation 32 (bijection) explained above. The output of this BS operation 32 is then provided as the output Ri+1 which is stored at storage element 38, and that becomes the input Ri for the next round as shown. The Ri value stored at storage element 16 is provided directly as the next left hand portion Li+1. As shown therefore the output values stored at storage elements (e.g., registers) 36 and 38 are fed back to the input storage elements respectively 12 and 16. Hence each round 10 is essentially identical. The encrypted value of such a block cipher after 1 round is expressed as L1 II R1.

FIG. 2 shows the associated process and logic apparatus 44 for generation of the sub keys KRi, KLi for the second and succeeding rounds. (In FIG. 1, only sub key KRi is used.) Beginning with the sub keys supplied from the previous round, these are respectively KLi and KRi stored in elements 46 and 48 (for instance registers). (The sub keys for the initial round are the initial key K split into portions KL0, KR0.) The KRi key in element 48 is first subject to the s-box substitution element 50 which operates as explained above. The output of s-box 50 is then applied to the RotateXOR 54. As shown, this RotateXOR function (described above) is applied to a 2×32 bit string of input data with (13+1) modulo 32 and (29+i) modulo 32. Since the block of data is here 64 bits long, it is split into two 32-bit words. The rotate XOR operation is applied to each word, so the operation is modulo 32. This can be done without the modulo, but less efficiently.

The output of the RotateXOR element 54 is then applied to the R function element 56, the output of which is coupled to XOR element 60 where it is combined with the sub key KLi from element 46, which is the left hand sub key from the previous round. The key for the first round is the main key. The output from XOR element 60 is then applied to the BS bijection element 64, which operates as explained above, and this bijected function then becomes the output key KRi+1 stored at element 70. The output key KLi+1 for the left hand side stored at 68 is merely the sub key KRi value from element 48 as shown. Hence the only use of sub key KLi is to generate the next round sub keys; KLi itself is not used for encryption, hence does not appear in FIG. 1. Of course the selection of left versus right as well as the various numerical parameters here are illustrative. Note that the decipherment, here as typical of symmetric ciphers, is essentially the inverse process of the encipherment accomplished by essentially the same algorithm and hence the description here is of the enciphering process. One of ordinary skill in the art will understand the deciphering process there from. Note that the key scheduling 44 shown in FIG. 2 is in many respects similar to the encipherment process 10. This is not unusual in block ciphers.

Another embodiment of the present block cipher is shown diagrammatically (for enciphering) as process and logic apparatus 72 in FIG. 3. This is in most respects identical to FIG. 1 and similar elements have the same reference numbers. As shown, the main difference is exchanging the positions of the r and R functions. In the FIG. 3 embodiment the key scheduling shown in FIG. 2 may be used.

The FIG. 3 embodiment has these operations:

1) The s-box 80 here also is a table lookup changing 4 bits into 4 other bits. This operation (function) s is summarized in hexadecimal notation by s={0×5, 0×a, 0×c, 0×0, 0×2, 0×7, 0'f, 0×4, 0×1, 0×e, 0×9, 0×3, 0×b, 0×6, 0×d, 0×8)}. (This differs somewhat from the s-box 24 of FIG. 1.) To simplify, we denote S as application of this function s to a block of any size.

2) Function r 76 in FIG. 3 corresponds, as in FIG. 1, to a 8-bit rotateRight.

3) The R function 78 here as in FIG. 1 at 14 is an equivalent to the shiftRow operation of AES. If one denotes the 64-bit word into 8 bytes numbered from 0 to 7, they are changed as follows (differing slightly from the R function 14 in FIG. 1):

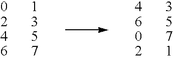

4) A key KRi 48 is provided as in FIG. 1 at each round using a XOR operation, as in FIG. 1 at 22.

5) As in FIG. 1 at 32, in FIG. 3 bijection BS 33 is an operation that creates a bijection on bytes. BS 33 in FIG. 3 uses the following bijection (differing slightly from BS operation 32 in FIG. 1):

Y=123*X+246 modulo 2⁸

In the FIG. 2 embodiment, the key schedule process 44 uses the function RotateXOR 54. Another key scheduling embodiment (not illustrated in the figures) uses a non invertible operation for key scheduling. The Blum-Blum-Shub (BBS) algorithm is well known for generation of random numbers. The basic BBS principle is to compute recursively squares and extract the quadratic residue. The squaring is computed modulo a modulus constructed as the product of two primes.

A similar process to BBS may be used here for this second key scheduling embodiment. For efficiency, one combines this key scheduling with a variable bit output. This provides a combination block/stream cipher or, e.g., a hash (one-way) function containing an initialization variable that may be updated via the BBS principle, the result being modified with other elements as Boolean and arithmetic operations. The main advantage of this method is to combine large number involvement with the combination of other arithmetic and Boolean operators.

The number of output bits for this key scheduling may be defined by another seeded function. For instance, let f be the BBS function computing the square modulo a particular modulus, and g be a pseudo random number generator function seeded at the user's convenience. The output of the BBS function is:

outputBuffer(i+1)=(outputBuffer(i)<<(g(i)& 0×0F))I((f(i) & 0×F)>>(16−(g(i) & 0×0F))

This way at each call to the BBS function, one generates (g(i) & 0×0F) new bits. The generated value may be used as an key schedule process for a block cipher. The obtained key from the previous round is then used as previously XORed with the right part Ri, at round i. This allows computing the key schedule and performing the encryption (encipherment) in parallel (at the same time) and in the same process; but note that at most 4 bits of data are generated at each BBS call. For each round, 64 bits of data are to be XORed with Ri. Then a given number of the BBS functions are carried out such that 64 bits are generated. This means 64 BBS calls are needed of the BBS function, at one bit per call. At each round the BBS function is called to obtain the sub key for that round. An accumulator is provided that is initialized to the original key (plus some other defined values) that is squared, and selected bits of the result are used as part of the sub key. The value in the accumulator may be modified using a value related to the current round.

This disclosure is illustrative and not limiting; further modifications will be apparent to those skilled in the art in light of this disclosure and are intended to fall within the scope of the appended claims.

1. A cryptographic method for processing data, comprising the acts of:
partitioning the data into blocks;
subjecting each block to a block cipher process having a plurality of rounds, each round including:
partitioning the block into first and second portions;
permuting the first portion;
providing a key;
logically combining the second portion with the key;
performing a substitution operation on the logically combined second portion, the substitution operation being performed by Boolean operations;
rotating the result of the substitution operation;
logically combining the permuted first portion with a result of the rotating;
subjecting a result of the second logically combining to a bijection;
wherein a result of the round is a first result that is the same as the first portion and a second result that is the result of the bijection.

2. The method of claim 1, wherein the substitution operation substitutes 4 output bits for 4 input bits.

3. The method of claim 2, wherein if the 4 input bits are designated a, b, c, and d, and the respective output bits are designated f₁,f₂,f₃, and f₄ each a function of a,b,c, and d, and A designates the bit complement to A, then:
f₁(a,b,c,d)=a*c+A*d
f₂(a,b,c,d)=a*d+A*c
f₃(a,b,c,d)=a*c*d+b*c+b*d
f₄(a,b,c,d)=a*b*c+a*d+b*c
wherein * designates the Boolean AND operation and + designates the Boolean OR operation.

4. The method of claim 1, wherein the bijection is expressed logically as Y=3*X+155 modulus 2⁸, X being the input value and Y being the output value of the bijection.

5. The method of claim 1, wherein the bijection can be expressed as a set of additions or a bit shift.

6. The method of claim 1, wherein the permutation permutes a set of bytes.

7. The method of claim 1, further comprising a key schedule process for each round to provide the key for the round, the key schedule process including:
performing a right rotate function on a value; and
logically combining a result of the right rotate function with the value.

8. The method of claim 1, wherein each of the acts of logically combining includes performing an exclusive OR operation.

9. The method of claim 1, wherein the substitution operation includes no table look up.

10. A computer readable medium storing computer code for performing the method of claim 1.

11. A computing device programmed to perform the method of claim 1.

12. A cryptographic apparatus embodying circuitry that performs the method of claim 1.

13. Apparatus for carrying out cryptographic process, the apparatus comprising:
a first storage element for storing a block of data;
a permutation element coupled to the first storage element for permuting a first portion of the block;
a key storage element for a key;
a first logic element coupled to the key storage element and to the first storage element thereby to logically combine the key with a second portion of the block of data;
a substitution element coupled to an output of the first logic element, the substitution element having a plurality of Boolean logic elements;
a rotating element coupled to an output of the substitution element;
a second logic element coupled to an output of the rotating element and an output of the permutation element, thereby to logically combine the permuted first portion with the rotated output of the substitution element;
a bijection element coupled to an output of the second logic element; and
an output storage element coupled to store in a first portion thereof the second portion of the data block and in second portion thereof an output of the bijection element;
wherein the second storage element is coupled to the first storage element thereby to perform a plurality of rounds of the cryptographic process on the block of data.

14. The apparatus of claim 13, wherein the substitution element includes no table look up.

15. The apparatus of claim 13, further comprising a key scheduling portion that generates the key, the key scheduling portion being coupled to the key storage element.
